(19) United States
(12) Patent Application Publication
(10) Pub. No.: US 2026/0303279 A1
(43) Pub. Date: Oct. 1, 2026

(54) MEASUREMENTS FOR FRAGMENTED CARRIER AGGREGATION (CA)

(71) Applicant: QUALCOMM Incorporated, San Diego, CA (US)

(72) Inventors: Prashant SHARMA, San Marcos, CA (US); Timo Ville VINTOLA, San Diego, CA (US); Stefan BRUECK, Neunkirchen am Brand (DE); Changhwan PARK, San Diego, CA (US); Nazmul ISLAM, Littleton, MA (US); Valentin Alexandru GHEORGHIU, Yokohama-shi (JP)

(21) Appl. No.: 19/575,869

(22) Filed: Mar. 23, 2026

Related U.S. Application Data
(60) Provisional application No. 63/780,035, filed on Mar. 28, 2025.

(51) Int. Cl. H04L 5/00; H04W 24/10

(52) U.S. Cl. CPC H04L 5/0042; H04L 5/0094; H04W 24/10

(57) ABSTRACT

Certain aspects of the present disclosure are directed towards a method for wireless communications by a base station (BS). The method generally includes: receiving one or more measurement quantities associated with one or more measurements performed by a user equipment (UE) within a band for reception on a first component carrier (CC) or a second component carrier (CC), the first CC and the second CC being non-contiguous in frequency; determining whether to use a single receive chain or separate receive chains to perform the reception on the first CC and the second CC based on the one or more measurement quantities; and outputting, to the UE, an indication of whether to use the single receive chain or the separate receive chains to perform the reception on the first CC and the second CC based on the determination.

### CROSS-REFERENCE TO RELATED APPLICATION

This application claims benefit of and priority to U.S. Provisional Application No. 63/780,035 filed Mar. 28, 2025, which is hereby expressly incorporated by reference herein in its entirety as if fully set forth below and for all applicable purposes.

### BACKGROUND

### Field of the Disclosure

Certain aspects of the present disclosure generally relate to wireless communications and, more particularly, to techniques for performing fragmented carrier aggregation.

### Description of Related Art

Electronic devices include computing devices such as desktop computers, notebook computers, tablet computers, smartphones, wearable devices like a smartwatch, internet servers, and so forth. These various electronic devices provide information, entertainment, social interaction, security, safety, productivity, transportation, manufacturing, and other services to human users. These various electronic devices depend on wireless communications for many of their functions. Wireless communication systems and devices are widely deployed to provide various types of communication content such as voice, video, packet data, messaging, broadcast, and so on. These systems may be capable of supporting communication with multiple users by sharing the available system resources (e.g., time, frequency, and power). Examples of such systems include code division multiple access (CDMA) systems, time division multiple access (TDMA) systems, frequency division multiple access (FDMA) systems, and orthogonal frequency division multiple access (OFDMA) systems (e.g., a Long Term Evolution (LTE) system or a New Radio (NR) system). Wireless devices may include a receiver for processing signals for reception. The receiver may include multiple receive chains in some implementations.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description,” one will understand how the features of this disclosure provide the advantages described herein.

Certain aspects of the present disclosure are directed towards a method for wireless communications by a user equipment (UE). The method generally includes: performing one or more measurements within a band for reception on a first component carrier (CC) or a second component carrier (CC), the first CC and the second CC being non-contiguous in frequency; and performing reception on at least one of the first CC or the second CC, wherein a determination of whether to use a single receive chain or separate receive chains to perform the reception on the first CC and the second CC is based on the one or more measurements.

Certain aspects of the present disclosure are directed towards a method for wireless communications by a base station (BS). The method generally includes: receiving one or more measurement quantities associated with one or more measurements performed by a user equipment (UE) within a band for reception on a first component carrier (CC) or a second component carrier (CC), the first CC and the second CC being non-contiguous in frequency; determining whether to use a single receive chain or separate receive chains to perform the reception on the first CC and the second CC based on the one or more measurement quantities; and outputting, to the UE, an indication of whether to use the single receive chain or the separate receive chains to perform the reception on the first CC and the second CC based on the determination.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be by reference to aspects, some of which are illustrated in the appended drawings. It is to be noted, however, that the appended drawings illustrate only certain aspects of this disclosure and are therefore not to be considered limiting of its scope, for the description may admit to other equally effective aspects.

FIG. 1 is a diagram of an example wireless communications network, in which certain aspects of the present disclosure may be practiced.

FIG. 2 is a block diagram of an example access point (AP) and example user terminals, in which certain aspects of the present disclosure may be practiced.

FIG. 3 is a block diagram of an example transceiver front end, in which certain aspects of the present disclosure may be practiced.

FIG. 4 illustrates an example receiver (Rx) chain of a wireless device.

FIG. 5 is a diagram illustrating reception on two component carriers using a single Rx chain or two Rx chains.

FIG. 6 is a diagram illustrating component carriers and a jammer in a frequency gap between the component carriers.

FIG. 7 is a diagram illustrating different operating states of a user equipment (UE), in accordance with certain aspects of the present disclosure.

FIG. 8 is a flow diagram illustrating example operations for transitioning between UE states, in accordance with certain aspects of the present disclosure.

FIGS. 9A-9D illustrates different measurements performed by a UE, in accordance with certain aspects of the present disclosure.

FIG. 10 depicts a method for wireless communications.

FIG. 11 depicts a method for wireless communications.

FIG. 12 depicts aspects of an example communications device.

FIG. 13 depicts aspects of an example communications device.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure are directed toward techniques for performing non-contiguous carrier aggregation (CA) using one or more receiver (Rx) radio frequency (RF) chains (e.g., referred to herein as “Rx chains” for short). For example, instead of receiving different component carriers (CCs) that are non-contiguous in frequency using separate Rx chains, a user equipment (UE) may receive the CCs using a single Rx chain, reducing power consumption. However, the single Rx chain may not be able to filter out (e.g., attenuate) any aggressor signals within a frequency gap between the CCs, as described in more detail herein. Certain aspects of the present disclosure provide techniques for performing measurements to facilitate a decision of whether the UE can operate with a single Rx chain for non-contiguous CA.

### EXAMPLE WIRELESS COMMUNICATIONS

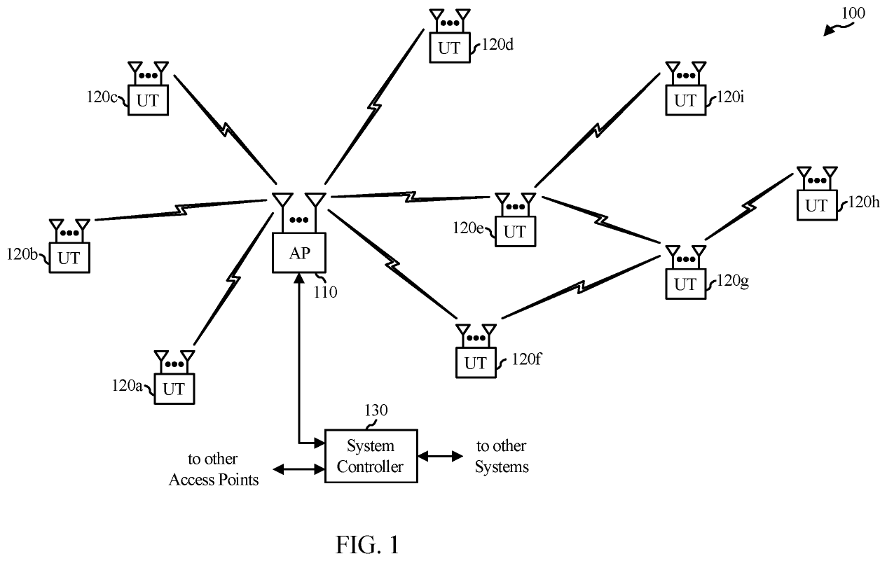

FIG. 1 illustrates a wireless communications system 100 with access points 110 and user terminals 120, in which aspects of the present disclosure may be practiced. For simplicity, only one access point 110 is shown in FIG. 1. An access point (AP) is generally a fixed station that communicates with the user terminals and may also be referred to as a base station (BS), an evolved Node B (eNB), a next generation Node B (gNB), or some other terminology. A user terminal (UT) may be fixed or mobile and may also be referred to as a mobile station (MS), an access terminal, user equipment (UE), a station (STA), a client, a wireless device, or some other terminology. A user terminal may be a wireless device, such as a cellular phone, a personal digital assistant (PDA), a handheld device, a wireless modem, a laptop computer, a tablet, a personal computer, etc.

Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

Wireless communications system 100 employs multiple transmit and multiple receive antennas for data transmission on the downlink and uplink. Access point 110 may be equipped with a number Nₐₚ of antennas to achieve transmit diversity for downlink transmissions and/or receive diversity for uplink transmissions. A set Nᵤ of selected user terminals 120 may receive downlink transmissions and transmit uplink transmissions. Each selected user terminal transmits user-specific data to and/or receives user-specific data from the access point. In general, each selected user terminal may be equipped with one or multiple antennas (i.e., Nᵤₜ≥1). The Nᵤ selected user terminals can have the same or different number of antennas.

Wireless communications system 100 may be a time division duplex (TDD) system or a frequency division duplex (FDD) system. For a TDD system, the downlink and uplink share the same frequency band. For an FDD system, the downlink and uplink use different frequency bands. Wireless communications system 100 may also utilize a single carrier or multiple carriers for transmission. Each user terminal 120 may be equipped with a single antenna (e.g., to keep costs down) or multiple antennas (e.g., where the additional cost can be supported).

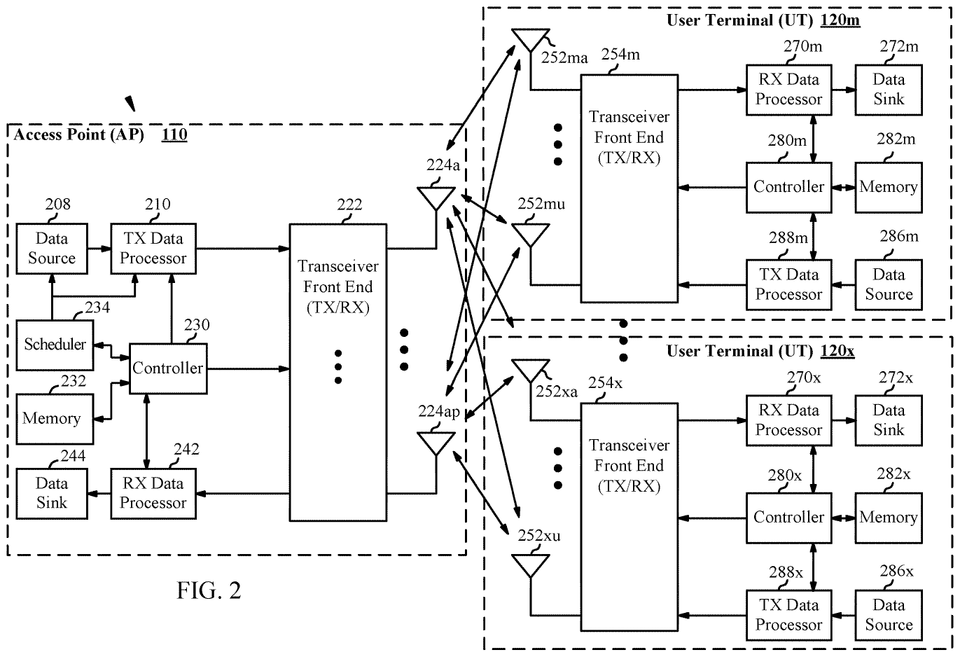

FIG. 2 shows a block diagram of access point 110 and two user terminals 120m and 120x in the wireless communications system 100. Access point 110 is equipped with Nₐₚ antennas 224a through 224ap. User terminal 120m is equipped with N_{ut,m} antennas 252ma through 252mu, and user terminal 120x is equipped with N_{ut,x} antennas 252xa through 252xu. Access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. Beam-steering, beamforming, or some other spatial processing technique may be used at the access point and/or user terminal.

On the uplink, at each user terminal 120 selected for uplink transmission, a transmitter (TX) data processor 288 receives traffic data from a data source 286 and control data from a controller 280. TX data processor 288 processes (e.g., encodes, interleaves, and modulates) the traffic data {dᵤₚ} for the user terminal based on the coding and modulation schemes associated with the rate selected for the user terminal and provides a data symbol stream {sᵤₚ}for one of the N_{ut,m} antennas. A transceiver front end (TX/RX) 254 (also known as a radio frequency front end (RFFE)) receives and processes (e.g., converts to analog, amplifies, filters, and frequency upconverts) a respective symbol stream to generate an uplink signal. The transceiver front end 254 may also route the uplink signal to one of the Nᵤₜ, ₘ antennas for transmit diversity via an RF switch, for example. The controller 280 may control the routing within the transceiver front end 254. Memory 282 may store data and program codes for the user terminal 120 and may interface with the controller 280.

A number Nᵤₚ of user terminals 120 may be scheduled for simultaneous transmission on the uplink. Each of these user terminals transmits its set of processed symbol streams on the uplink to the access point.

At access point 110, Nₐₚ antennas 224a through 224ap receive the uplink signals from all Nᵤₚ user terminals transmitting on the uplink. For receive diversity, a transceiver front end 222 may select signals received from one of the antennas 224 for processing. The signals received from multiple antennas 224 may be combined for enhanced receive diversity. The access point's transceiver front end 222 also performs processing complementary to that performed by the user terminal's transceiver front end 254 and provides a recovered uplink data symbol stream. The recovered uplink data symbol stream is an estimate of a data symbol stream {sᵤₚ} transmitted by a user terminal. A receiver (RX) data processor 242 processes (e.g., demodulates, deinterleaves, and decodes) the recovered uplink data symbol stream in accordance with the rate used for that stream to obtain decoded data. The decoded data for each user terminal may be provided to a data sink 244 (e.g., corresponding to data sink 272 of UT) for storage and/or a controller 230 for further processing.

On the downlink, at access point 110, a TX data processor 210 receives traffic data from a data source 208 for N_{dn} user terminals scheduled for downlink transmission, control data from a controller 230 and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 may provide a downlink data symbol streams for one of more of the N_{dn} user terminals to be transmitted from one of the Nₐₚ antennas. The transceiver front end 222 receives and processes (e.g., converts to analog, amplifies, filters, and frequency upconverts) the symbol stream to generate a downlink signal. The transceiver front end 222 may also route the downlink signal to one or more of the Nₐₚ antennas 224 for transmit diversity via an RF switch, for example. The controller 230 may control the routing within the transceiver front end 222. Memory 232 may store data and program codes for the access point 110 and may interface with the controller 230.

At each user terminal 120, N_{ut,m} antennas 252 receive the downlink signals from access point 110. For receive diversity at the user terminal 120, the transceiver front end 254 may select signals received from one or more of the antennas 252 for processing. The signals received from multiple antennas 252 may be combined for enhanced receive diversity. The user terminal's transceiver front end 254 also performs processing complementary to that performed by the access point's transceiver front end 222 and provides a recovered downlink data symbol stream. An RX data processor 270 processes (e.g., demodulates, deinterleaves, and decodes) the recovered downlink data symbol stream to obtain decoded data for the user terminal.

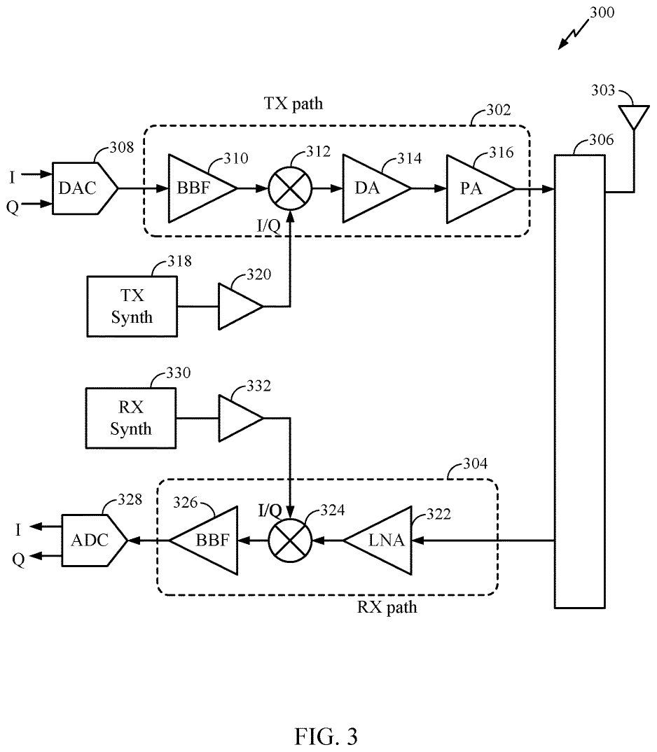

FIG. 3 is a block diagram of an example transceiver front end 300, such as transceiver front ends 222, 254 in FIG. 2, in which aspects of the present disclosure may be practiced. The transceiver front end 300 includes at least one transmit (TX) path 302 (also known as a transmit chain) for transmitting signals via one or more antennas and at least one receive (RX) path 304 (also known as a receive chain) for receiving signals via the one or more antennas. When the TX path 302 and the RX path 304 share an antenna 303, the paths may be connected with the antenna via an interface 306, which may include any of various suitable radio frequency (RF) devices, such as a switch, a duplexer, a diplexer, a multiplexer, and the like.

Receiving in-phase (I) or quadrature (Q) baseband analog signals from a digital-to-analog converter (DAC) 308, the TX path 302 may include a baseband filter (BBF) 310, a mixer 312, a driver amplifier (DA) 314, and a power amplifier (PA) 316. The BBF 310, the mixer 312, the DA 314, and the PA 316 may be included in a radio frequency integrated circuit (RFIC). In some cases, the PA 316 may be external to the RFIC. In some cases, the DA 314 may include a pre-DA that may drive a DA, where the DA drives the PA 316.

The BBF 310 filters the baseband signals received from the DAC 308, and the mixer 312 mixes the filtered baseband signals with a transmit local oscillator (LO) signal to convert the baseband signal of interest to a different frequency (e.g., upconvert from baseband to RF). This frequency-conversion process produces the sum and difference frequencies of the LO frequency and the frequencies of the baseband signal of interest. The sum and difference frequencies are referred to as the beat frequencies. The beat frequencies are typically in the RF range, such that the signals output by the mixer 312 are typically RF signals, which may be amplified by the DA 314 and/or by the PA 316 before transmission by the antenna 303. While one mixer 312 is illustrated, several mixers may be used to upconvert the filtered baseband signals to one or more intermediate frequencies and to thereafter upconvert the intermediate frequency (IF) signals to a frequency for transmission.

The RX path 304 includes a low noise amplifier (LNA) 322, a mixer 324, and a baseband filter (BBF) 326. The LNA 322, the mixer 324, and the BBF 326 may be included in a radio frequency integrated circuit (RFIC), which may or may not be the same RFIC that includes the TX path components. RF signals received via the antenna 303 may be amplified by the LNA 322, and the mixer 324 mixes the amplified RF signals with a receive local oscillator (LO) signal to convert the RF signal of interest to a different baseband frequency (e.g., downconvert). The baseband signals output by the mixer 324 may be filtered by the BBF 326 before being converted by an analog-to-digital converter (ADC) 328 to digital I and/or Q signals for digital signal processing.

Certain transceivers may employ a variable-frequency oscillator (e.g., a voltage-controlled oscillator (VCO) or a digitally controlled oscillator (DCO)) to generate a stable, tunable LO signal with a particular tuning range. Thus, the transmit LO signal may be produced by a TX frequency synthesizer 318, which may be buffered or amplified by amplifier 320 before being mixed with the baseband signals in the mixer 312. Similarly, the receive LO signal may be produced by an RX frequency synthesizer 330, which may be buffered or amplified by amplifier 332 before being mixed with the RF signals in the mixer 324. For certain aspects, a single frequency synthesizer may be used for both the TX path 302 and the RX path 304.

While FIGS. 1-3 provide wireless communications as an example application in which certain aspects of the present disclosure may be implemented to facilitate understanding, certain aspects described herein may be used in any of various other suitable systems.

### EXAMPLE TECHNIQUES FOR FRAGMENTED CARRIER AGGREGATION (CA)

Certain aspects of the present disclosure are directed towards performing carrier aggregation (CA) using downlink (DL) fragmented carriers. Fragmented CA generally refers to CA with component carriers that are non-contiguous in frequency.

Certain aspects provide techniques for reducing the number of UE receiver (Rx) radio frequency (RF) chains (e.g., from using separate Rx RF chains per CC to one Rx RF chain for multiple CCs) for a single DL band (e.g., with a frequency span≤100 MHz) containing two non-contiguous CCs within a CA combination (e.g., for an inter-operator co-located scenario). In some cases, there may be up to 6 dB DL received power spectral density imbalance between the two non-contiguous CCs.

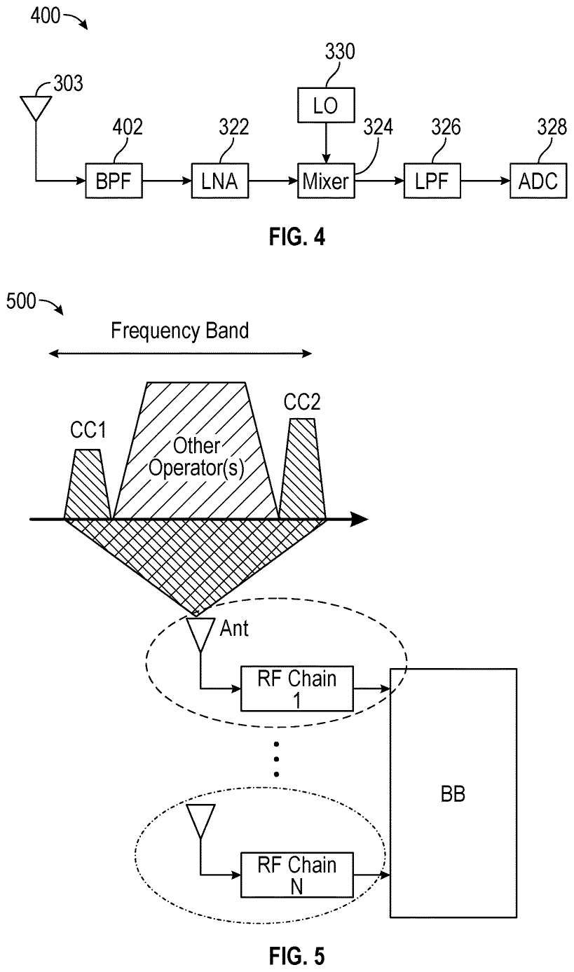

FIG. 4 illustrates an example Rx chain 400 of a wireless device (e.g., UE). As shown, the Rx chain may include the antenna 303 coupled to a bandpass filter (BPF) 402 that may attenuate signals outside the operating bandwidth of the UE. A filtered signal from the BPF 402 may be amplified using the LNA 322 and upconverted via the mixer 324 using an LO signal from a synthesizer 330. The upconverted signal may be filtered via a baseband filter (BBF) 326 (e.g., a low-pass filter (LPF)) and provided to an analog-to-digital converter (ADC) 328 for conversion from the analog domain to the digital domain for processing by a baseband (BB) processor. While an example Rx chain is described to facilitate understanding, any suitable Rx chain may be used.

FIG. 5 is a diagram 500 illustrating two component carriers (CC1 and CC2) that may be received using a single Rx chain or two Rx chains. As shown, a wireless device (e.g., UE) may include N Rx chains (N being any positive integer) that may be coupled to a baseband (BB) processor, as shown.

In some scenarios, a UE may be configured to perform reception on CC1 and CC2 using a single Rx chain (e.g., as opposed to using separate Rx chains for CC1 and CC2), reducing the power consumption of the UE. The frequency gap between CC1 and CC2 may be occupied by signaling from a different operator, such as a base station (BS) or one or more other UEs.

Any DL (or UL) signal (e.g., also referred to herein as an “aggressor signal”) in the frequency gap (e.g., occupied by a different network or operator) may act as a jammer to the UE receiving on DL over CC1 and CC2 using a single Rx chain. If using separate RX chains, the aggressor signal may be attenuated using one or more filters of each of the RX chains. That is, a filter of the Rx chain (e.g., BPF 402 or BBF 326) for receiving CC1 may be configured to attenuate signals outside CC1, and the filter of the Rx chain for receiving CC2 may be configured to attenuate signals outside CC2. But if a single Rx chain is used, the jammer falls within the operating band of the chain. Thus, the filter of the Rx chain cannot be tuned to filter the jammer as the pass-band of the filter has to be wide enough to include both CC1 and CC2, and the jammer falls between CC1 and CC2.

The interference may be from a BS or UEs belonging to the other network(s) operating in the frequency gap. Such interference may cause leakage or automatic gain control (AGC) saturation, degrading receiver performance. For example, when using a single wideband Rx chain, the AGC may lock based on the power of the aggressor signal in the frequency gap. The AGC may set a gain level based on the aggressor signal power, which may result in insufficient amplification of the signals on CC1 and CC2. This insufficient amplification may lead to higher quantization noise at the ADC and degraded signal-to-noise ratio (SNR) for the desired signals on CC1 and CC2.

With a single RF chain, the network (e.g., base station) may enable such CA only if there is no receiver performance degradation (or at least a performance degradation that is less than some threshold) expected due to using the single Rx chain. For instance, a single Rx chain may be used if a reasonably low power spectral density is provided for co-located adjacent channel operators. Thus, the UE may be used to evaluate expected performance degradation and/or inform the network of whether the UE can support intra-band, non-contiguous CA with a single Rx chain. Such an evaluation may be performed with UE-based measurements, as described in more detail herein.

In some cases, a UE may be operating with an Rx chain for reception on CC1, and the network may add/activate CC2 for reception via the same Rx chain. In other cases, the UE may currently operate with a single Rx chain for reception on CC1 and CC2 and may evaluate whether there is any performance degradation because of a jammer. Based on the evaluation, the UE may determine whether the UE should continue CA operations on the single Rx. If not, the UE may drop one of the CCs or switch to CA with two Rx chains.

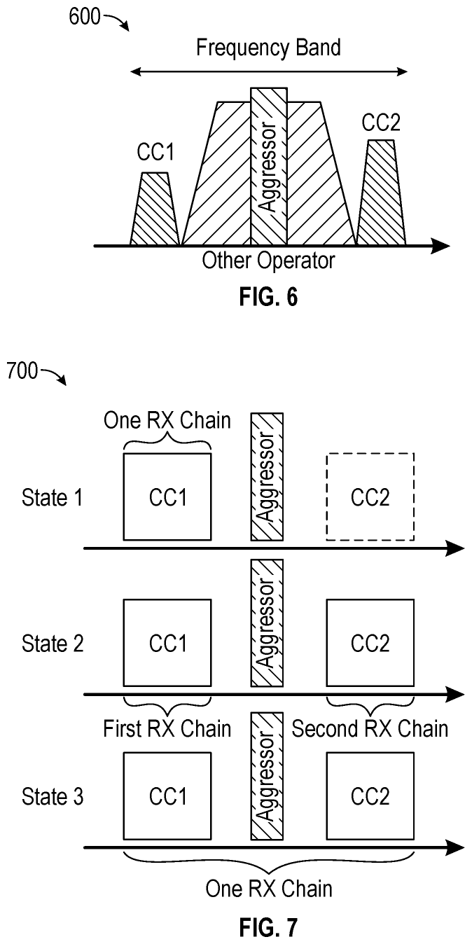

FIG. 6 is a diagram 600 illustrating component carriers CC1 and CC2 and a jammer (e.g., aggressor signal) in a frequency gap between CC1 and CC2. As shown, the UE may perform measurements using one or more techniques described herein to evaluate any performance degradation due to using a single Rx chain fragmented CA. In other words, the UE may perform measurements to identify a level of performance degradation due to the aggressor signal between CC1 and CC2 as part of evaluating whether to use a single Rx chain for reception on both CC1 and CC2.

FIG. 7 is a diagram 700 illustrating different operating states of a UE, in accordance with certain aspects of the present disclosure. As shown, in state 1, the UE may be configured to receive on CC1 using an Rx chain. In state 2, the wireless device may be configured to receive on CC1 using a first Rx chain and CC2 using a second Rx chain. The UE is configured for reception on non-contiguous (NC) CCs (CC1 and CC2) and uses two Rx chains to receive the CCs and meet existing NC downlink carrier aggregation (DLCA) performance specifications. In state 3, the UE may be configured for the reception of NC CCs using a single Rx chain.

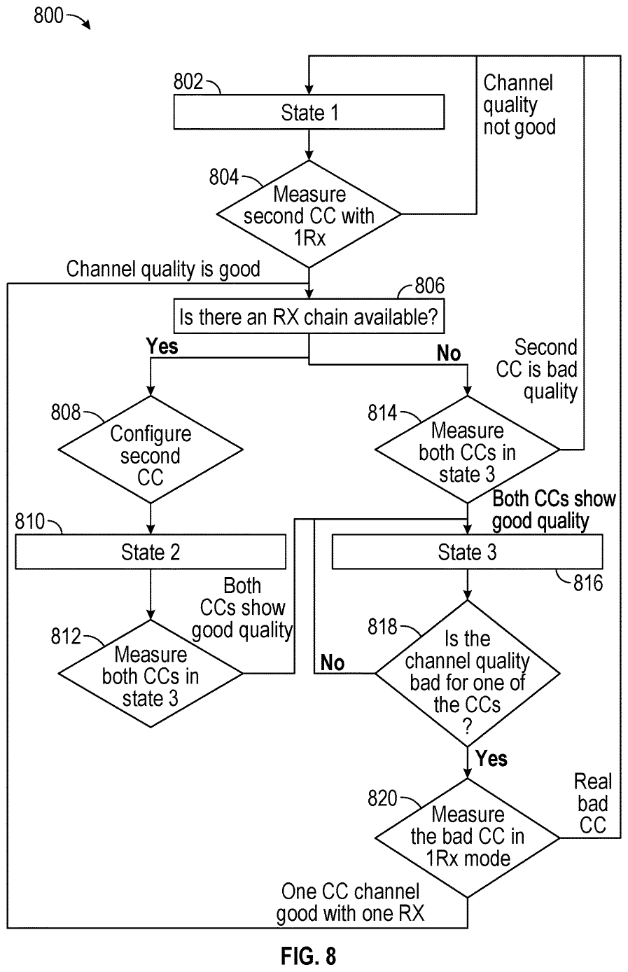

FIG. 8 is a flow diagram illustrating example operations 800 for transitioning between UE states, in accordance with certain aspects of the present disclosure. The operations 800 may be performed by a UE (e.g., user terminal 120 of FIG. 1).

At block 802, the UE may be operating in state 1 (e.g., receiving on CC1 with a first Rx chain) as described with respect to FIG. 7. At block 804, the UE may perform a measurement on CC2 with one Rx chain (e.g., the first Rx chain or a second Rx chain) and determine whether the channel quality on CC2 is above some threshold (e.g., whether a measurement quantity (result) is above some threshold). Any suitable measurements may be used as described in more detail herein. If so, at block 806, the UE may determine whether there is a second Rx chain available. If so, at block 808, the UE configures for reception on the second CC using the second Rx chain, resulting in the UE being configured in state 2 at block 810.

From state 2, the UE may perform a measurement on both CCs using separate Rx chains. That is, the UE may be configured in state 3 (e.g., at least temporarily) to make the measurement at block 812. If the measurement quantity of both CCs is above a certain threshold, the UE may be configured in state 3 at block 816.

While in state 3, at block 818, the UE may perform one or more measurements and determine whether the measurement quantity (e.g., measurement result) of one of the CCs (e.g., CC2) has dropped below a threshold. If so, at block 820, the UE may perform a measurement on the CC (e.g., CC2 with the measuring quantity that dropped below the threshold) with a single Rx (e.g., configured at least temporarily in state 1) and determine whether to transition back to state 1 based on the measurement. If at block 820 the UE determines that the one CC (e.g., CC2) measured with the one Rx chain (as in state 1) provides sufficient channel quality for communication, the UE may transition to block 806 and determine whether another Rx chain is available. If at block 820, the UE determines that the one CC (e.g., CC2) measured with one Rx chain does not provide sufficient channel quality, the UE may be configured back to state 1 at block 802 to operate with a single CC and a single Rx chain.

If at block 806 the UE determines that a second Rx chain is not available, the UE measures both CCs in state 3 at block 814. If the measurement quantity of both CCs is above some threshold, the UE transitions to state 3 at block 816.

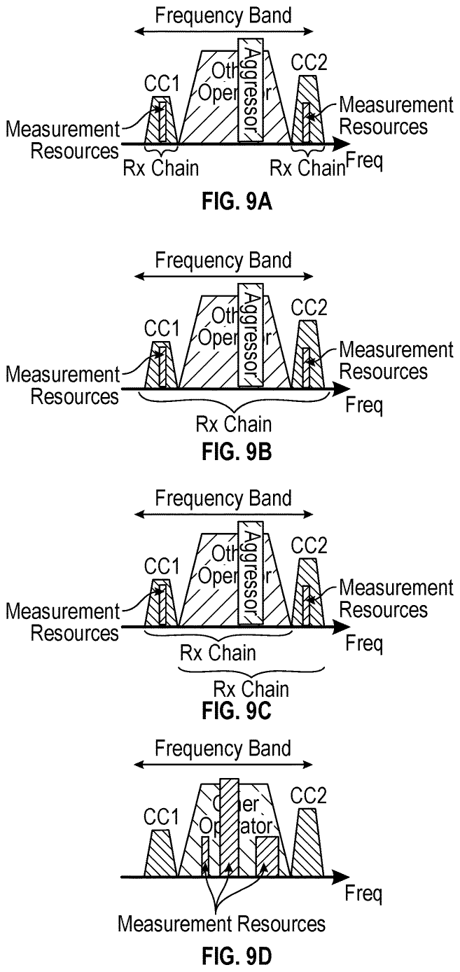

FIGS. 9A-9D illustrates different measurements performed by a wireless device (e.g., UE), in accordance with certain aspects of the present disclosure. For example, the UE may perform measurements using one or more configurations to evaluate any performance degradation due to a single Rx chain fragmented CA.

In some aspects, the UE may derive a first set of measurement quantities (referred to as “measurement quantities #1). In some aspects, to derive measurement quantity #1, the UE may perform measurements on CC1 and CC2 using separate Rx chains as shown in FIG. 9A. That is, the UE may perform each measurement while at least temporarily configured in state 2 for measurement. In some aspects, when two Rx chains are available, the measurements on CC1 and CC2 using separate Rx chains may be performed simultaneously (e.g., at the same time). In some aspects, to derive measurement quantities #1, the UE may perform measurements on CC1 and CC2 using a narrowband Rx chain (e.g., while at least temporarily configured in state 1 for measurement) for each measurement. For example, the UE may perform the measurements on CC1 and CC2 separately using separate narrow band Rx chains (e.g., where each RX chain is tuned with a band associated with the corresponding CC) or using a single narrow band Rx chain that may be first tuned to perform measurement on CC1 then tuned to perform measurement on CC2.

The UE may also derive a second set of measurement quantities (referred to as “measurement quantities #2). For measurement quantities #2, the UE may perform measurements on CC1 and CC2 using a single Rx chain on a wideband (e.g., a band that spans both CC1 and CC2 as shown in FIG. 9B). In other words, for measurement quantities #2, the UE may be at least temporarily configured in state 3 for measurement. Alternatively, for measurement quantities #2, the UE may use a single Rx chain to perform a wideband measurement where the wideband spans CC1 and the frequency gap between CC1 and CC2 (e.g., and another wideband measurement where the wideband spans CC2 and the frequency gap between CC1 and CC2), as shown in FIG. 9C. Thus, the wideband measurement captures the performance degradation on either CC due to any aggressor in the frequency gap. The UE may identify the difference between measurement quantities #1 and measurement quantities #2 to be used to determine whether to enable CA with a single RF Rx chain. In some cases, the UE may provide measurement quantities #1 and #2 (or the difference between the measurement quantities #1 and #2) to the network to be used to determine whether to enable CA with a single RF Rx chain. Calculating the difference between the measurement quantities #1 and #2 may include calculating the difference in the measurement quantities for CC1 (e.g., from measurement quantities #1 and #2) and the difference in the measurement quantities for CC2 (e.g., for measurement quantities #1 and #2).

As described, any suitable measurement may be used. Each measurement may be an RSRP, reference signal receive quality (RSRQ), or signal-to-interference-plus-noise ratio (SINR) measurement based on either a synchronization signal block (SSB) or channel state information (CSI)-reference signal (RS).

In some aspects, as shown in FIG. 9D, the UE may perform one or more measurements within the frequency gap between CC1 and CC2. The one or more measurement quantities may be used to decide whether to enable CA with a single RF Rx chain. In this case, the measurement quantity may be RSSI. As shown, aggressor signals (e.g., from different sources and frequencies) may have different power levels.

In some aspects, the UE may opportunistically perform the measurements described herein and indicate to the network whether the UE can support fragmented CA with a single Rx. That is, the UE may not report any measurement quantities to the network and simply indicate whether CA with a single Rx chain can be enabled.

Additionally or alternatively, the UE may indicate to the network that the UE can support CA with a single Rx chain but with relaxed performance metrics. The UE may first check that certain performance metrics are met before communicating. The performance metrics may include, for example, radio frequency (RF) metrics, demodulation metrics, or radio resource management (RRM) metrics, which may include signal-to-noise ratio (SNR), throughput, or adjacent channel leakage ratio (ACLR) metrics. For example, relaxed demodulation metrics may include meeting throughput specifications at a higher SNR level, meeting reduced throughput at the same SNR level, or relaxed physical downlink shared channel (PDSCH) decoding specifications. In some aspects, the indication that the UE can support CA with a single Rx chain may be sent as a part of UE assistance information (UAI).

Certain aspects are directed towards techniques for identifying measurement resources to be used. Measurement resources may be determined based on UE implementation. For example, the UE may autonomously (e.g., without network input) determine what frequency resources to measure, when to perform the measurements, and how frequently to perform the measurements.

In some aspects, measurement resources may be configured by the network. For example, the network may configure the measurement resources that the UE is to use for the measurements. The configuration may be provided by radio resource control (RRC) signaling, media access control (MAC)-control element (CE), or downlink control information (DCI). In some cases, RRC signaling may provide the configuration, but the BS may use MAC-CE or DCI to indicate when the UE may start performing the measurements. In other cases, the UE may autonomously determine when to start measurements on the configured resources.

In some aspects, the resources may be periodic, aperiodic, or semi-persistent. For instance, the UE may perform the measurements in accordance with a certain periodicity. For semi-persistent resources, the network may configure one or more resources (e.g., frequency resources) to be used for measurements using radio resource control (RRC) signaling, but then transmit a medium access control (MAC)-control element (CE) or downlink control information (DCI) to indicate when the UE is to start performing one or more measurements on the configured one or more resources. In some aspects, the periodicity and duration of the measurements can be autonomously determined by the UE for periodic or semi-persistent resources. For aperiodic resources, the UE may autonomously determine whether to perform or when to perform the one or more measurements.

In some aspects, the UE performs measurements on the measurement resource(s) configured by the network and reports the measurement results to the network. The UE may either report, separately, measurement quantities #1 and #2 described herein, or report the difference between the two measurement quantities #1 and #2. For example, the UE may report measurement quantities #1 and #2 (or the difference between measurement quantities #1 and #2, allowing the network to consider the measurement quantities to decide whether the UE should use a single Rx chain for CA. When the UE performs the measurement within the frequency gap between CC1 and CC2 as described herein, the UE may report the absolute value of the measurement quantity to be used by the network to decide whether the UE should use a single Rx chain for CA.

Measurement reports may be transmitted to the network by the UE periodically/semi-persistently, aperiodically, or upon an event trigger. To report periodically/semi-persistently, the network may configure the periodicity with which the UE sends the measurement reports. To report aperiodically, the UE sends a measurement report upon request by the network. For event-triggered reporting, the UE sends a measurement report if the measurement meets a certain criteria. For example, if the difference between measurement quantities #1 and measurement quantities #2 exceeds some threshold, the UE may report the difference to the network. When performing the measurements within the frequency gap between CC1 and CC2, the UE may report the associated measurement quantities if all the measurement quantities meet a configured threshold, if at least one of the measurement quantities meet a configured threshold, or at least a certain ratio of the measurement quantities for the configured measurement resources meet a configured threshold.

In some aspects, the network (e.g., base station) may aggregate or consider measurement reports from multiple UEs operating in the same band to make a more informed decision about whether to enable fragmented CA with a single Rx chain for a particular UE. For example, even if a first UE reports low interference levels, the network may determine based on measurement reports from other UEs that interferers are present in the frequency gap and may interfere with the first UE at a later time. Thus, the network may use measurement information from multiple UEs to obtain a better sense of the interference environment in the frequency band.

In some aspects, the network may configure the UE with one or more measurement resources. When multiple resources are configured, the UE may perform measurements on all or a subset of the configured measurement resources. For example, the network may configure Y measurement resources (e.g., Y being a positive integer), and the UE may perform measurements on any X out of the Y measurement resources (e.g., X being a positive integer less than Y). In some cases, the resources may at least partially overlap in frequency. A resource may span the entire bandwidth of the frequency gap between the CCs. In some aspects, the network may configure multiple narrowband RSSI resources (as opposed to a single wideband resource) to more accurately capture the interference level and location of a narrowband interferer. For example, if the UE measures over the entire bandwidth of the frequency gap, the average energy level may be lower and may not accurately reflect the interference impact of a narrowband interferer. By configuring multiple narrowband measurement resources, the network may obtain a more accurate picture of the interference environment within the frequency gap.

### Example Operations

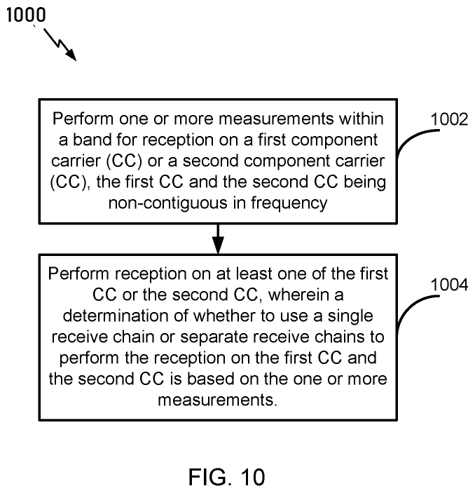

FIG. 10 shows an example of a method 1000 of wireless communications at a user equipment (UE).

At 1002, the UE performs one or more measurements within a band for reception on a first component carrier (CC) or a second component carrier (CC), the first CC and the second CC being non-contiguous in frequency.

At 1004, the UE performs reception on at least one of the first CC or the second CC, wherein a determination of whether to use a single receive chain or separate receive chains to perform the reception on the first CC and the second CC is based on the one or more measurements.

In some aspects, the one or more measurements includes: a first measurement on a resource within the first CC; and a second measurement on a resource within the second CC. In some aspects, the first measurement is performed using a first receive chain; and the second measurement is performed using a second receive chain different than the first receive chain or using the first receive chain via radio frequency (RF) retuning. In some aspects, the first measurement and the second measurement are performed using the single receive chain tuned with a wideband.

In some aspects, the one or more measurements include a first set of measurements yielding a first set of measurement quantities, the first set of measurements comprising: measurements on the first CC and the second CC using separate receive chains configured with narrow bands associated with the first CC and the second CC, respectively; or a measurement on each of the first CC and the second CC using the single receive chain configured with a narrow band associated with the first CC and the second CC respectively. In some aspects the one or more measurements further include a second set of measurements yielding a second set of measurement quantities, the second set of measurements comprising: measurements on the first CC and the second CC using the single receive chain with a wideband including the first CC and the second CC; or a measurement on each of the first CC and the second CC using the single receive chain with a wide band including the first CC or the second CC, respectively, and a frequency gap between the first CC and the second CC. The determination of whether to use the single receive chain or the separate receive chains to perform the reception on the first CC and the second CC may be based on a difference between the first set of measurement quantities and the second set of measurement quantities. In some aspects, the method further comprises sending, to a base station, a measurement report associated with the one or more measurements, the measurement report including: the first set of measurement quantities and the second set of measurement quantities; or the difference between measurement quantities for the first CC from the first set of measurement quantities and the second set of measurement quantities, and the difference between measurement quantities for the second CC from the first set of measurement quantities and the second set of measurement quantities. The method may also include receiving an indication of whether to use the single receive chain or the separate receive chains to perform the reception on the first CC and the second CC based on the measurement report.

In some aspects, the one or more measurements include at least one measurement within a frequency gap between the first CC and the second CC. The method may also include: sending, to a base station, a measurement report associated with the one measurement within the frequency gap between the first CC and the second CC; and receiving an indication of whether to use the single receive chain or the separate receive chains to perform the reception on the first CC and the second CC based on the measurement report.

In some aspects, the method may also include transmitting, to a base station, an indication of whether the UE is able to support the reception on the first CC and the second CC using the single receive chain.

In some aspects, the method may also include receiving, from a base station, one or more messages indicating of at least one of: one or more of time or frequency resources to perform the one or more measurements; and how frequently to perform the one or more measurements. The one or more messages may include: a radio resource control (RRC) message configuring the one or more of time of frequency resources; and a medium access control (MAC) control element (CE) or downlink control information (DCI) indicating when to start performing the one or more measurements.

In some aspects, the method may include: transmitting one or more measurement reports associated with the one or more measurements; and receiving an indication of whether to use the single receive chain or the separate receive chains to perform the reception on the first CC and the second CC based on the measurement report. The method may also include receiving, from a base station, an indication of a periodicity associated transmitting the one or more measurement reports.

The method may also include receiving, from a base station, a measurement report request, wherein the one or more measurement reports are transmitted in response to the measurement report request. The method may include identifying an occurrence of an event associated with the one or more measurements, wherein the one or more measurements reports are transmitted based on the occurrence of the event.

The method may also include receiving an indication of multiple resources to perform the one or more measurements. The one or more measurements may be performed for a subset of the multiple resources. At least two of the multiple resources at least partially overlap in frequency.

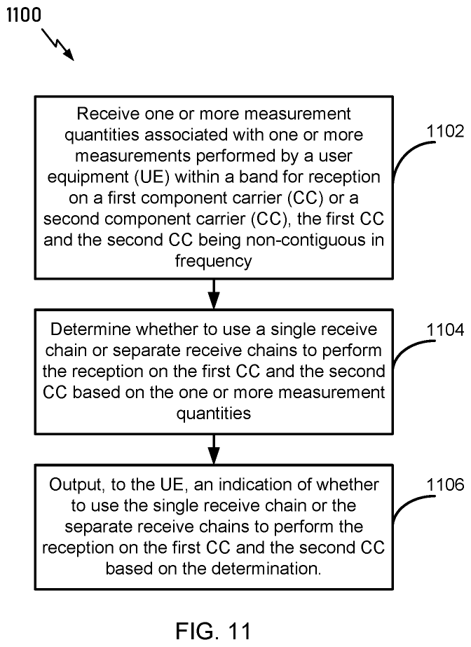

FIG. 11 shows an example of a method 1100 of wireless communications at a base station (BS).

At 1102, the BS may receive one or more measurement quantities associated with one or more measurements performed by a user equipment (UE) within a band for reception on a first component carrier (CC) or a second component carrier (CC), the first CC and the second CC being non-contiguous in frequency.

At 1104, the BS may determine whether to use a single receive chain or separate receive chains to perform the reception on the first CC and the second CC based on the one or more measurement quantities.

At 1106, the BS may output, to the UE, an indication of whether to use the single receive chain or the separate receive chains to perform the reception on the first CC and the second CC based on the determination.

The one or more measurement quantities include a first set of measurement quantities associated a first set of measurements performed by the UE, the first set of measurements comprising: measurements on the first CC and the second CC using separate receive chains configured with narrow bands associated with the first CC and the second CC, respectively; or a measurement on each of the first CC and the second CC using the single receive chain configured with a narrow band associated with the first CC and the second CC respectively. The one or more measurement quantities further include a second set of measurement quantities associated with a second set of measurements performed by the UE, the second set of measurements comprising: measurements on the first CC and the second CC using the single receive chain with a wideband including the first CC and the second CC; or a measurement on each of the first CC and the second CC using the single receive chain with a wide band including the first CC or the second CC, respectively, and a frequency gap between the first CC and the second CC. The determination of whether to use the single receive chain or the separate receive chains to perform the reception on the first CC and the second CC may be based on a difference between the first set of measurement quantities and the second set of measurement quantities. Receiving the one or more measurement quantities may include receiving, from the UE, a measurement report including: the first set of measurement quantities and the second set of measurement quantities; or the difference between measurements quantities for the first CC from the first set of measurement quantities and the second set of measurements quantifies, and the difference between measurements quantities for the second CC from the first set of measurement quantities and the second set of measurement quantities.

The one or more measurements may include at least one measurement within a frequency gap between the first CC and the second CC. Receiving the one or more measurement quantities may include receiving, from the UE, a measurement report associated with the at least one measurement within the frequency gap between the first CC and the second CC.

In some aspects, the method also includes receiving, from the UE, an indication of whether the UE is able to support the reception on the first CC and the second CC using the single receive chain.

The method may also include transmitting, to the UE, one or more messages indicating of at least one of: one or more of time or frequency resources to perform the one or more measurements; or how frequently to perform the one or more measurements. The one or more messages may include: a radio resource control (RRC) message configuring the one or more of time of frequency resources; and a medium access control (MAC) control element (CE) or downlink control information (DCI) indicating when to start performing the one or more measurements.

In some aspects the method may also include transmitting, to the UE, an indication of a periodicity associated with transmitting the one or more measurements.

In some aspects the method may also include transmitting, to the UE, a measurement report request, wherein the one or more measurements are transmitted in response to the measurement report request.

In some aspects the method may also include transmitting, to the UE, an indication of multiple resources to perform the one or more measurements. At least two of the multiple resources may at least partially overlap in frequency.

### Example Communications Device(s)

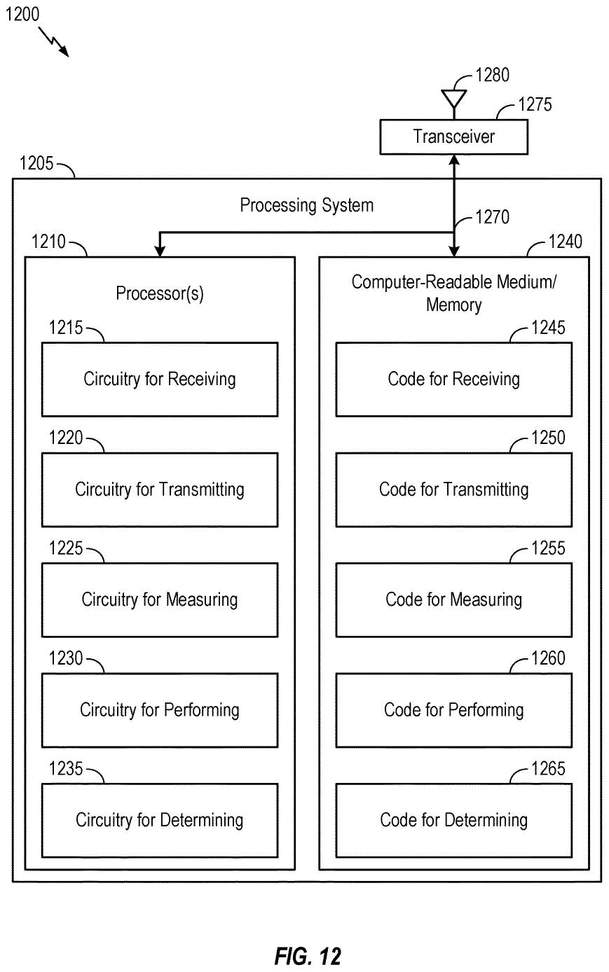

FIG. 12 depicts aspects of an example communications device 1200. In some aspects, communications device 1200 is a user equipment.

The communications device 1200 includes a processing system 1205 coupled to the transceiver 1275 (e.g., a transmitter and/or a receiver). The transceiver 1275 is configured to transmit and receive signals for the communications device 1200 via the antenna 1280, such as the various signals as described herein. The processing system 1205 may be configured to perform processing functions for the communications device 1200, including processing signals received and/or to be transmitted by the communications device 1200.

The processing system 1205 includes one or more processors 1210. The one or more processors 1210 are coupled to a computer-readable medium/memory 1240 via a bus 1270. In certain aspects, the computer-readable medium/memory 1240 is configured to store instructions (e.g., computer-executable code) that when executed by the one or more processors 1210, cause the one or more processors 1210 to perform the method 1000 described with respect to FIG. 10, or any aspect related to it. Note that reference to a processor performing a function of communications device 1200 may include one or more processors 1210 performing that function of communications device 1200.

In the depicted example, computer-readable medium/memory 1240 stores code (e.g., executable instructions), such as code for receiving 1245, code for transmitting 1250, code for measuring 1255, code for performing 1260, and code for determining 1265. Processing of the code for receiving 1245, code for transmitting 1250, code for measuring 1255, code for performing 1260, and code for determining 1265 may cause the communications device 1200 to perform the method 1000 described with respect to FIG. 10, or any aspect related to it.

The one or more processors 1210 include circuitry configured to implement (e.g., execute) the code stored in the computer-readable medium/memory 1240, including circuitry such as circuitry for receiving 1215, circuitry for transmitting 1220, circuitry for measuring 1225, circuitry for performing 1230, and circuitry for determining 1235. Processing with circuitry for receiving 1215, circuitry for transmitting 1220, circuitry for measuring 1225, circuitry for performing 1230, and circuitry for determining 1235 may cause the communications device 1200 to perform the method 1000 described with respect to FIG. 10, or any aspect related to it. Various components of the communications device 1200 may provide means for performing the method 1000 described with respect to FIG. 10, or any aspect related to it.

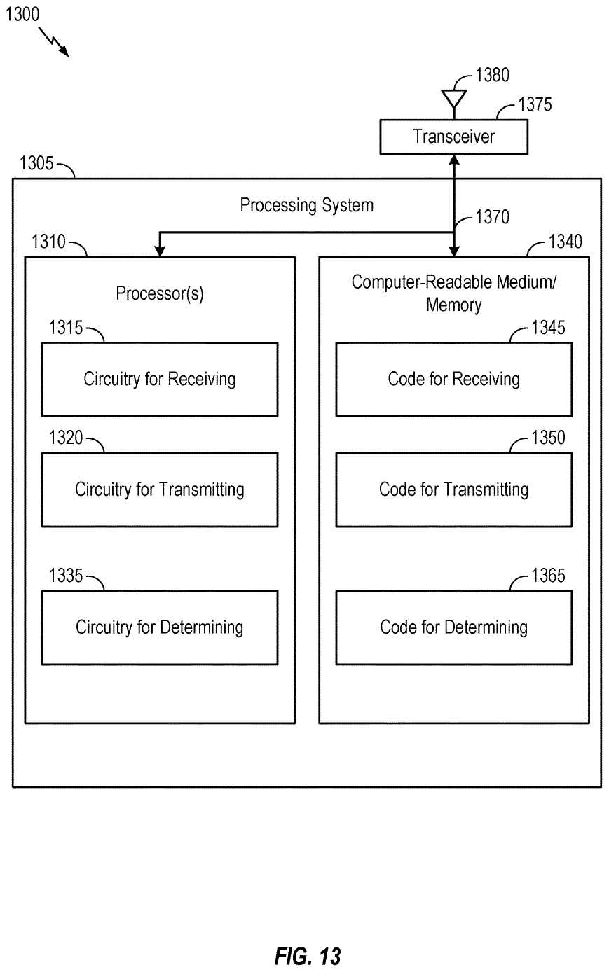

FIG. 13 depicts aspects of an example communications device 1300. In some aspects, communications device 1300 is a network entity, such as a BS.

The communications device 1300 includes a processing system 1305 coupled to the transceiver 1375 (e.g., a transmitter and/or a receiver) and/or a network interface. The transceiver 1375 is configured to transmit and receive signals for the communications device 1300 via the antenna 1380, such as the various signals as described herein. The network interface is configured to obtain and send signals for the communications device 1300 via communication link(s), such as a backhaul link, midhaul link, and/or fronthaul link as described herein. The processing system 1305 may be configured to perform processing functions for the communications device 1300, including processing signals received and/or to be transmitted by the communications device 1300.

The processing system 1305 includes one or more processors 1310. The one or more processors 1310 are coupled to a computer-readable medium/memory 1340 via a bus 1370. In certain aspects, the computer-readable medium/memory 1340 is configured to store instructions (e.g., computer-executable code) that when executed by the one or more processors 1310, cause the one or more processors 1310 to perform the method 1100 described with respect to FIG. 11, or any aspect related to it. Note that reference to a processor of communications device 1300 performing a function may include one or more processors 1310 of communications device 1300 performing that function.

In the depicted example, computer-readable medium/memory 1340 stores code (e.g., executable instructions), such as code for receiving 1345, code for transmitting 1350, and code for determining 1365. Processing of the code for receiving 1345, code for transmitting 1350, and code for determining 1365 may cause the communications device 1300 to perform the method 1100 described with respect to FIG. 11, or any aspect related to it.

The one or more processors 1310 include circuitry configured to implement (e.g., execute) the code stored in the computer-readable medium/memory 1340, including circuitry such as circuitry for receiving 1315, circuitry for transmitting 1320, and circuitry for determining 1335. Processing with circuitry for receiving 1315, circuitry for transmitting 1320, and circuitry for determining 1335 may cause the communications device 1300 to perform the method 1100 described with respect to FIG. 11, or any aspect related to it. Various components of the communications device 1300 may provide means for performing the method 1100 described with respect to FIG. 11, or any aspect related to it.

### EXAMPLE ASPECTS

Aspect 1: A method for wireless communications by a user equipment (UE), comprising: performing one or more measurements within a band for reception on a first component carrier (CC) or a second component carrier (CC), the first CC and the second CC being non-contiguous in frequency; and performing reception on at least one of the first CC or the second CC, wherein a determination of whether to use a single receive chain or separate receive chains to perform the reception on the first CC and the second CC is based on the one or more measurements.

Aspect 2: The method of Aspect 1, wherein the one or more measurements includes: a first measurement on a resource within the first CC; and a second measurement on a resource within the second CC.

Aspect 3: The method of Aspect 2, wherein: the first measurement is performed using a first receive chain; and the second measurement is performed using a second receive chain different than the first receive chain or using the first receive chain via radio frequency (RF) retuning.

Aspect 4: The method of Aspect 2 or 3, wherein the first measurement and the second measurement are performed using the single receive chain tuned with a wideband.

Aspect 5: The method according to any of Aspects 1-4, wherein the one or more measurements include a first set of measurements yielding a first set of measurement quantities, the first set of measurements comprising: measurements on the first CC and the second CC using separate receive chains configured with narrow bands associated with the first CC and the second CC, respectively; or a measurement on each of the first CC and the second CC using the single receive chain configured with a narrow band associated with the first CC and the second CC respectively.

Aspect 6: The method of Aspect 5, wherein: the one or more measurements further include a second set of measurements yielding a second set of measurement quantities, the second set of measurements comprising: measurements on the first CC and the second CC using the single receive chain with a wideband including the first CC and the second CC; or a measurement on each of the first CC and the second CC using the single receive chain with a wide band including the first CC or the second CC, respectively, and a frequency gap between the first CC and the second CC ; and the determination of whether to use the single receive chain or the separate receive chains to perform the reception on the first CC and the second CC is based on a difference between the first set of measurement quantities and the second set of measurement quantities.

Aspect 7: The method of Aspect 6, further comprising: sending, to a base station, a measurement report associated with the one or more measurements, the measurement report including: the first set of measurement quantities and the second set of measurement quantities; or the difference between measurement quantities for the first CC from the first set of measurement quantities and the second set of measurement quantities, and the difference between measurement quantities for the second CC from the first set of measurement quantities and the second set of measurement quantities; and receiving an indication of whether to use the single receive chain or the separate receive chains to perform the reception on the first CC and the second CC based on the measurement report.

Aspect 8: The method according to any of Aspects 1-7, wherein the one or more measurements include at least one measurement within a frequency gap between the first CC and the second CC.

Aspect 9: The method of Aspect 8, further comprising: sending, to a base station, a measurement report associated with the one measurement within the frequency gap between the first CC and the second CC; and receiving an indication of whether to use the single receive chain or the separate receive chains to perform the reception on the first CC and the second CC based on the measurement report.

Aspect 10: The method according to any of Aspects 1-9, further comprising transmitting, to a base station, an indication of whether the UE is able to support the reception on the first CC and the second CC using the single receive chain.

Aspect 11: The method according to any of Aspects 1-10, further comprising receiving, from a base station, one or more messages indicating at least one of: one or more of time or frequency resources to perform the one or more measurements; and how frequently to perform the one or more measurements.

Aspect 12: The method of Aspect 11, wherein the one or more messages include: a radio resource control (RRC) message configuring the one or more of time or frequency resources; and a medium access control (MAC) control element (CE) or downlink control information (DCI) indicating when to start performing the one or more measurements.

Aspect 13: The method according to any of Aspects 1-12, further comprising: transmitting one or more measurement reports associated with the one or more measurements; and receiving an indication of whether to use the single receive chain or the separate receive chains to perform the reception on the first CC and the second CC based on the measurement report.

Aspect 14: The method of Aspect 13, further comprising receiving, from a base station, an indication of a periodicity associated transmitting the one or more measurement reports.

Aspect 15: The method of Aspect 13 or 14, further comprising receiving, from a base station, a measurement report request, wherein the one or more measurement reports are transmitted in response to the measurement report request.

Aspect 16: The method according to any of Aspects 13-15, further comprising identifying an occurrence of an event associated with the one or more measurements, wherein the one or more measurements reports are transmitted based on the occurrence of the event.

Aspect 17: The method according to any of Aspects 1-16, further comprising receiving an indication of multiple resources to perform the one or more measurements.

Aspect 18: The method of Aspect 17, wherein the one or more measurements are performed for a subset of the multiple resources.

Aspect 19: The method of Aspect 17 or 18, wherein at least two of the multiple resources at least partially overlap in frequency.

Aspect 20: A method for wireless communications by a base station (BS), comprising: receiving one or more measurement quantities associated with one or more measurements performed by a user equipment (UE) within a band for reception on a first component carrier (CC) or a second component carrier (CC), the first CC and the second CC being non-contiguous in frequency; and determining whether to use a single receive chain or separate receive chains to perform the reception on the first CC and the second CC based on the one or more measurement quantities; and outputting, to the UE, an indication of whether to use the single receive chain or the separate receive chains to perform the reception on the first CC and the second CC based on the determination.

Aspect 21: The method of Aspect 20, wherein the one or more measurement quantities include a first set of measurement quantities associated a first set of measurements performed by the UE, the first set of measurements comprising: measurements on the first CC and the second CC using separate receive chains configured with narrow bands associated with the first CC and the second CC, respectively; or a measurement on each of the first CC and the second CC using the single receive chain configured with a narrow band associated with the first CC and the second CC respectively.

Aspect 22: The method of Aspect 21, wherein: the one or more measurement quantities further include a second set of measurement quantities associated with a second set of measurements performed by the UE, the second set of measurements comprising: measurements on the first CC and the second CC using the single receive chain with a wideband including the first CC and the second CC; or a measurement on each of the first CC and the second CC using the single receive chain with a wide band including the first CC or the second CC, respectively, and a frequency gap between the first CC and the second CC ; and the determination of whether to use the single receive chain or the separate receive chains to perform the reception on the first CC and the second CC is based on a difference between the first set of measurement quantities and the second set of measurement quantities.

Aspect 23: The method of Aspect 22, wherein receiving the one or more measurement quantities includes receiving, from the UE, a measurement report including: the first set of measurement quantities and the second set of measurement quantities; or the difference between measurement quantities for the first CC from the first set of measurement quantities and the second set of measurement quantities, and the difference between measurement quantities for the second CC from the first set of measurement quantities and the second set of measurement quantities.

Aspect 24: The method according to any of Aspects 20-23, wherein the one or more measurements include at least one measurement within a frequency gap between the first CC and the second CC.

Aspect 25: The method of Aspect 24, wherein receiving the one or more measurement quantities includes receiving, from the UE, a measurement report associated with the at least one measurement within the frequency gap between the first CC and the second CC.

Aspect 26: The method according to any of Aspects 20-25, further comprising receiving, from the UE, an indication of whether the UE is able to support the reception on the first CC and the second CC using the single receive chain.

Aspect 27: The method according to any of Aspects 20-26, further comprising transmitting, to the UE, one or more messages indicating at least one of: one or more of time or frequency resources to perform the one or more measurements; or how frequently to perform the one or more measurements.

Aspect 28: The method of Aspect 27, wherein the one or more messages include: a radio resource control (RRC) message configuring the one or more of time or frequency resources; and a medium access control (MAC) control element (CE) or downlink control information (DCI) indicating when to start performing the one or more measurements.

Aspect 29: The method according to any of Aspects 20-28, further comprising transmitting, to the UE, an indication of a periodicity associated with transmitting the one or more measurements.

Aspect 30: The method according to any of Aspects 20-29, further comprising transmitting, to the UE, a measurement report request, wherein the one or more measurements are transmitted in response to the measurement report request.

Aspect 31: The method according to any of Aspects 20-30, further comprising transmitting, to the UE, an indication of multiple resources to perform the one or more measurements.

Aspect 32: The method of Aspect 31, wherein at least two of the multiple resources at least partially overlap in frequency.

Aspect 33: An apparatus, comprising: at least one memory comprising executable instructions; and at least one processor configured to execute the executable instructions and cause the apparatus to perform a method in accordance with any combination of Clauses 1-32.

Aspect 34: An apparatus, comprising means for performing a method in accordance with any combination of Clauses 1-32.

Aspect 35: A non-transitory computer-readable medium comprising executable instructions that, when executed by at least one processor of an apparatus, cause the apparatus to perform a method in accordance with any combination of Clauses 1-32.

Aspect 36: A computer program product embodied on a computer-readable storage medium comprising code for performing a method in accordance with any combination of Clauses 1-32.

### ADDITIONAL CONSIDERATIONS

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B and object B touches object C, then objects A and C may still be considered coupled to one another—even if objects A and C do not directly physically touch each other. For instance, a first object may be coupled to a second object even though the first object is never directly physically in contact with the second object. The terms “circuit” and “circuitry” are used broadly and intended to include both hardware implementations of electrical devices and conductors that, when connected and configured, enable the performance of the functions described in the present disclosure, without limitation as to the type of electronic circuits.

The apparatus and methods described in the detailed description are illustrated in the accompanying drawings by various blocks, modules, components, circuits, steps, processes, algorithms, etc. (collectively referred to as “elements”). These elements may be implemented using hardware, for example.

One or more of the components, steps, features, and/or functions illustrated herein may be rearranged and/or combined into a single component, step, feature, or function or embodied in several components, steps, or functions. Additional elements, components, steps, and/or functions may also be added without departing from features disclosed herein. The apparatus, devices, and/or components illustrated herein may be configured to perform one or more of the methods, features, or steps described herein.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover at least: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

It is to be understood that the claims are not limited to the precise configuration and components illustrated above. Various modifications, changes and variations may be made in the arrangement, operation and details of the methods and apparatus described above without departing from the scope of the claims.

1. A method for wireless communications by a user equipment (UE), comprising:
performing one or more measurements within a band for reception on a first component carrier (CC) or a second component carrier (CC), the first CC and the second CC being non-contiguous in frequency; and
performing reception on at least one of the first CC or the second CC, wherein a determination of whether to use a single receive chain or separate receive chains to perform the reception on the first CC and the second CC is based on the one or more measurements.

2. The method of claim 1, wherein the one or more measurements includes:
a first measurement on a resource within the first CC; and
a second measurement on a resource within the second CC.

3. The method of claim 2, wherein:
the first measurement is performed using a first receive chain; and
the second measurement is performed using a second receive chain different than the first receive chain or using the first receive chain via radio frequency (RF) retuning.

4. The method of claim 2, wherein the first measurement and the second measurement are performed using the single receive chain tuned with a wideband.

5. The method of claim 1, wherein the one or more measurements include a first set of measurements yielding a first set of measurement quantities, the first set of measurements comprising:
measurements on the first CC and the second CC using separate receive chains configured with narrow bands associated with the first CC and the second CC, respectively; or
a measurement on each of the first CC and the second CC using the single receive chain configured with a narrow band associated with the first CC and the second CC respectively.

6. The method of claim 5, wherein:
the one or more measurements further include a second set of measurements yielding a second set of measurement quantities, the second set of measurements comprising:
measurements on the first CC and the second CC using the single receive chain with a wideband including the first CC and the second CC; or
a measurement on each of the first CC and the second CC using the single receive chain with a wide band including the first CC or the second CC, respectively, and a frequency gap between the first CC and the second CC ; and
the determination of whether to use the single receive chain or the separate receive chains to perform the reception on the first CC and the second CC is based on a difference between the first set of measurement quantities and the second set of measurement quantities.

7. The method of claim 6, further comprising:
sending, to a base station, a measurement report associated with the one or more measurements, the measurement report including:
the first set of measurement quantities and the second set of measurement quantities; or
the difference between measurement quantities for the first CC from the first set of measurement quantities and the second set of measurement quantities, and the difference between measurement quantities for the second CC from the first set of measurement quantities and the second set of measurement quantities; and
receiving an indication of whether to use the single receive chain or the separate receive chains to perform the reception on the first CC and the second CC based on the measurement report.

8. The method of claim 1, wherein the one or more measurements include at least one measurement within a frequency gap between the first CC and the second CC.

9. The method of claim 8, further comprising:
sending, to a base station, a measurement report associated with the one measurement within the frequency gap between the first CC and the second CC; and
receiving an indication of whether to use the single receive chain or the separate receive chains to perform the reception on the first CC and the second CC based on the measurement report.

10. The method of claim 1, further comprising transmitting, to a base station, an indication of whether the UE is able to support the reception on the first CC and the second CC using the single receive chain.

11. The method of claim 1, further comprising receiving, from a base station, one or more messages indicating at least one of:
one or more of time or frequency resources to perform the one or more measurements; and
how frequently to perform the one or more measurements.

12. The method of claim 11, wherein the one or more messages include:
a radio resource control (RRC) message configuring the one or more of time or frequency resources; and
a medium access control (MAC) control element (CE) or downlink control information (DCI) indicating when to start performing the one or more measurements.

13. The method of claim 1, further comprising:
transmitting one or more measurement reports associated with the one or more measurements; and
receiving an indication of whether to use the single receive chain or the separate receive chains to perform the reception on the first CC and the second CC based on the measurement report.

14. The method of claim 13, further comprising receiving, from a base station, an indication of a periodicity associated transmitting the one or more measurement reports.

15. The method of claim 13, further comprising receiving, from a base station, a measurement report request, wherein the one or more measurement reports are transmitted in response to the measurement report request.

16. The method of claim 13, further comprising identifying an occurrence of an event associated with the one or more measurements, wherein the one or more measurements reports are transmitted based on the occurrence of the event.

17. The method of claim 1, further comprising receiving an indication of multiple resources to perform the one or more measurements.

18. The method of claim 17, wherein the one or more measurements are performed for a subset of the multiple resources.

19. A method for wireless communications by a base station (BS), comprising:
receiving one or more measurement quantities associated with one or more measurements performed by a user equipment (UE) within a band for reception on a first component carrier (CC) or a second component carrier (CC), the first CC and the second CC being non-contiguous in frequency; and
determining whether to use a single receive chain or separate receive chains to perform the reception on the first CC and the second CC based on the one or more measurement quantities; and
outputting, to the UE, an indication of whether to use the single receive chain or the separate receive chains to perform the reception on the first CC and the second CC based on the determination.

20. An apparatus for wireless communications by a user equipment (UE), comprising:
at least one memory for storing computer-executable instructions; and
one or more processors operatively coupled to the at least one memory and configured to execute the computer-executable instructions to cause the apparatus to:
perform one or more measurements within a band for reception on a first component carrier (CC) or a second component carrier (CC), the first CC and the second CC being non-contiguous in frequency; and
perform reception on at least one of the first CC or the second CC, wherein a determination of whether to use a single receive chain or separate receive chains to perform the reception on the first CC and the second CC is based on the one or more measurements.
